(19) United States
(12) Patent Application Publication
(10) Pub. No.: US 2021/0389163 A1
(43) Pub. Date: Dec. 16, 2021

(54) System and method for coupling distributed sensors information to fiber optic embedded in an optical cable using acoustic vibrations

(71) Applicant: TECHNOLOGY INNOVATION MOMENTUM FUND (ISRAEL) LIMITED PARTNERSHIP, Tel Aviv (IL)

(72) Inventors: Avishay Eyal, Givat Shmuel (IL); Shaul Ozeri, Tel Aviv (IL); Nadav Arbel, Ramat Gan (IL)

(21) Appl. No.: 17/286,467

(22) PCT Filed: Dec. 10, 2019
(86) PCT No.: PCT/IB2019/060607

§ 371 Date: Apr. 18, 2021

Related U.S. Application Data
(60) Provisional application No. 62/778,917, filed on Dec. 13, 2018.

(51) Int. Cl. G01D 5/353; G01H 9/00

(52) U.S. Cl. CPC G01D 5/353; G01H 9/004

(57) ABSTRACT

A system (10) includes an optical source, multiple coupler units (22), a controller (20), and a detector (123). The optical source is configured to transmit an optical signal into an optical cable (40). The multiple coupler units are coupled to the optical cable and are each configured to (i) accept one or more configuration parameters, (ii) receive data from one or more sensors (30), (iii) modulate the data onto an acoustical signal in accordance with the configuration parameters, and (iv) modulate a mechanical strain applied to the optical cable with the acoustic signal, so as to modulate the optical signal with the data. The controller is configured to coordinate and send the configuration parameters to the multiple coupler units. The detector is configured to receive the optical signal from the optical cable, and to demodulate the data that was modulated onto the optical signal by the multiple coupler units.

### CROSS-REFERENCE TO RELATED APPLICATIONS

This application claims the benefit of U.S. Provisional Patent Application 62/778,917, filed Dec. 13, 2018, whose disclosure is incorporated herein by reference.

### FIELD OF THE INVENTION

The present invention relates generally to sensor networks, and particularly to methods and systems for coupling sensor information to an optical cable using ultrasonic vibrations.

### BACKGROUND OF THE INVENTION

Various techniques are known in the art for transforming a section of an optical fiber into an optical modulator. For example, U.S. Patent Application Publication 2008/0166120 describes a modulator arrangement for acoustically modulating optical radiation. The modulator arrangement has a waveguide portion formed from a flexible material, a vibrator element for generating acoustic vibrations, and a coupling arrangement for releasably coupling the vibrating element to the waveguide portion. The coupling arrangement include a first coupling member secured to the waveguide portion, and a second coupling member secured to the vibrator element.

### SUMMARY OF THE INVENTION

A system includes an optical source, multiple coupler units, and a detector. The optical source is configured to transmit an optical signal into an optical cable. The multiple coupler units are coupled to the optical cable and are each configured to (i) accept one or more configuration parameters, (ii) receive data from one or more sensors. (iii) modulate the data onto an acoustical signal in accordance with the configuration parameters, and (iv) modulate a mechanical strain applied to the optical cable with the acoustic signal, so as to modulate the optical signal with the data. The detector is configured to receive the optical signal from the optical cable, and to demodulate the data that was modulated onto the optical signal by the multiple coupler units.

In some embodiments, the configuration parameters for a given coupler unit include a center frequency allocated to the acoustic signal of the given coupler unit, and the given coupler unit is configured to generate the acoustic signal having the allocated center frequency. n other embodiments, the configuration parameters for a given coupler unit include a bandwidth allocated to the acoustic signal of the given coupler unit, and the given coupler unit is configured to modulate the data onto the acoustical signal while not exceeding the allocated bandwidth.

In some embodiments, the configuration parameters for a given coupler unit include relative power levels to be set at respective frequencies within a bandwidth of the acoustic signal.

In an embodiment, the coupler units are configured to harvest electrical power by induction from an electrical conductor that runs along the optical cable.

In another embodiment, two or more optical reflectors are inserted at predefined locations along the optical cable, and the optical source is configured to generate the optical signal such that reflections of the optical signal from the optical reflectors do not overlap when reaching the detector.

In some embodiments, the system further includes a controller, which is configured to coordinate and send the configuration parameters to the multiple coupler units.

In some embodiments, the controller and a given coupler unit are configured to perform a closed-loop equalization process that equalizes a phase change across a bandwidth of the acoustic signal of the given coupler unit.

In some embodiments, the controller is configured to send to a given coupler unit an instruction to switch to a “listen only” mode, and the given coupler unit is configured, upon receiving the instruction, to refrain from modulating the mechanical strain.

In an embodiment, in response to a request from a given coupler unit, the controller is configured to (a) assign an increased bandwidth to the given coupler unit for a defined time slot by modifying the configuration parameters, and (b) instruct one or more of the other coupler units to switch to a “listen only” mode during the defined time slot.

In another embodiment, the controller is configured to assign respective addresses to the coupler units, and to send the addresses to the coupler units.

In some embodiments, the controller is configured to initiate assignment of the addresses by sending a broadcast message. In response to the broadcast message, each coupler unit is configured to randomly select a respective carrier frequency for the acoustic signal, and to modulate the mechanical strain applied to the optical cable with the acoustic signal having the randomly-selected center frequency. The controller is configured to assign each address to a respective randomly-selected center frequency, and to notify the coupler units of the address assigned to each randomly-selected center frequency. Each coupler unit is configured to adopt the address that is assigned to the randomly-selected center frequency of the coupler unit.

In some embodiments, the controller is configured to detect that two or more coupler units have randomly selected a same center frequency, and in response to instruct the two or more coupler units to randomly select the center frequency again.

In an embodiment, the controller is configured to detect that two or more coupler units have randomly selected a same center frequency by failing to demodulate the data on a given center frequency. In another embodiment, the controller is configured to detect that two or more coupler units have randomly selected a same center frequency by detecting that a number of the center frequencies is smaller than a number of the coupler units in the system.

There is additionally provided, in accordance with an embodiment of the present invention, a method including transmitting an optical signal into an optical cable. In each of multiple coupler units, which are coupled to the optical cable, (i) one or more configuration parameters are accepted, (ii) data is received from one or more sensors, (iii) the data is modulated onto an acoustical signal in accordance with the configuration parameters, and (iv) a mechanical strain applied to the optical cable is modulated with the acoustic signal, so as to modulate the optical signal with the data. The optical signal is received from the optical cable, and the data that was modulated onto the optical signal by the multiple coupler units is demodulated.

In some embodiments, the method further includes coordinating and sending the configuration parameters to the multiple coupler units.

There is further provided, in accordance with an embodiment of the present invention, an apparatus, including an acoustic transducer and a mechanical element. The acoustic transducer is coupled to an optical cable and is configured to modulate a mechanical strain applied to the optical cable with an acoustic signal, so as to modulate an optical signal traversing the optical cable with data. The mechanical element is configured to apply to the optical cable a returning force that opposes the mechanical strain applied by the acoustic transducer.

In some embodiments, the mechanical element is configured to apply pre-tension to the optical cable by pre-distorting a shape of the optical cable. In other embodiments, the mechanical element includes a spring.

In an embodiment, the mechanical element includes a second acoustic transducer. In another embodiment, the apparatus further includes a flextural element, which is coupled between the acoustic transducer and the optical cable and is configured to amplify a force of the acoustic transducer.

In some embodiments, the acoustic transducer and the mechanical element include respective first and second flextural elements operating in anti-phase relative to one another.

In some embodiments, the acoustic transducer has a radius that varies as a function of the acoustic signal, so as to modulate the mechanical strain applied to the optical cable.

In an embodiment, the apparatus further includes a proximity sensor configured to sense a vibration of the optical cable in response to the mechanical strain applied by the acoustic transducer.

In another embodiment, the apparatus further includes a microcontroller, configured to adapt an amplitude of the acoustic signal provided to the acoustic transducer responsively to the vibration sensed by the proximity sensor.

There is furthermore provided, in accordance with an embodiment of the present invention, a method including, using an acoustic transducer, which is coupled to an optical cable, modulating a mechanical strain applied to the optical cable with an acoustic signal, so as to modulate an optical signal traversing the optical cable with data. Using a mechanical element, a returning force is applied to the optical cable, that opposes the mechanical strain applied by the acoustic transducer.

There is further provided, in accordance with an embodiment of the present invention, a system including an optical source, multiple coupler units, and a detector. The optical source is configured to transmit optical signals having different optical carrier frequencies into an optical cable, wherein optical signals that differ in optical carrier frequency are interlaced in time. The multiple coupler units are coupled to the optical cable and are each configured to (i) accept one or more configuration parameters, (ii) receive data from one or more sensors, (iii) modulate the data onto an acoustical signal in accordance with the configuration parameters, and (iv) modulate a mechanical strain applied to the optical cable with the acoustic signal, so as to modulate the optical signal with the data. The detector is configured to receive the interlaced optical signals from the optical cable, and to demodulate the data that was modulated onto the optical signal by the multiple coupler units.

There is further provided, in accordance with an embodiment of the present invention, a system including an optical source, multiple coupler units, a detector. The optical source is configured to transmit optical signals having a same optical carrier frequency into different fibers of an optical cable, wherein optical signals propagating in different fibers are interlaced in time. The multiple coupler units are coupled to the optical cable and are each configured to (i) accept one or more configuration parameters, (ii) receive data from one or more sensors, (iii) modulate the data onto an acoustical signal in accordance with the configuration parameters, and (iv) modulate a mechanical strain applied to the optical cable with the acoustic signal, so as to modulate the optical signal with the data. The detector is configured to receive the interlaced optical signals from the optical cable, and to demodulate the data that was modulated onto the optical signal by the multiple coupler units.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a sensor system, in accordance with an embodiment of the present invention;

FIGS. 2A and 2B are sensor systems configured to operate in transmission and reflection modes, respectively, in accordance with embodiments of the present invention;

FIG. 3 is a graph schematically showing a process of frequency allocation among the coupler units of the system of FIG. 1, in accordance with an embodiment of the present invention;

FIG. 4 is a graph schematically showing the expected spectral response to detected frequency-divided signals, in accordance with an embodiment of the present invention;

FIG. 5 is a graph schematically showing an incorporation Rayleigh backscatter pattern of the frequency-divided signals, in accordance with an embodiment of the present invention;

FIG. 6 is a graph schematically showing fiber-divided signals according to frequency, in accordance with an embodiment of the present invention;

FIG. 7 is a sensor system configured to operate in reflection mode and having two sensing fibers multiplexed according to the scheme of FIG. 4, in accordance with an embodiment of the present invention;

FIG. 8 is a sensor system configured to operate in reflection mode and having two sensing fibers multiplexed according to the scheme of FIG. 6, in accordance with another embodiment of the present invention;

FIG. 9 is a graph schematically showing linear frequency modulated (LFM) pulses that are used by the systems as interrogator pulses to increase allocated bandwidth (BW), in accordance with an embodiment of the present invention;

FIG. 10 is a flow chart of a method of power equalization over multiple modulation frequencies, in accordance with an embodiment of the present invention;

FIG. 11 is a graph schematically showing a detected phase change for each frequency derived by the process of FIG. 10, in accordance with an embodiment of the present invention;

FIGS. 12A-12C are schematic side views of an optical cable strained by forces applied to the cable along a lateral axis of the cable, in accordance with embodiments of the present invention;

FIG. 13 is a schematic side view of a flextural construction applied to modulate an optical cable, in accordance with an embodiment of the present invention;

FIG. 14 is a schematic side view of a two-lateral force layout for generating modulated longitudinal strain to fibers in an optical cable, in accordance with an embodiment of the present invention;

FIG. 15 is a schematic side view of a longitudinal-lateral force layout for generating modulated strain to fibers in an optical cable, in accordance with an embodiment of the present invention;

FIG. 16 is a schematic side view of a piezo-driven flextural construction applied to modulate strain in an optical cable, in accordance with an embodiment of the present invention;

FIG. 17 is a schematic side view of a doubly piezo-driven flextural construction applied to modulate strain in an optical cable, in accordance with an embodiment of the present invention;

FIG. 18 is a schematic side view of a circular transducer applied to modulate strain in optical cable, in accordance with an embodiment of the present invention;

FIG. 19 is a schematic side view of a return-force flextural construction applied to modulate strain in an optical cable, in accordance with an embodiment of the present invention;

FIG. 20 is a schematic side view of a Langevin piezoelectric transducer applied to modulate strain in an optical cable, in accordance with an embodiment of the present invention;

FIG. 21 is a schematic side view of a bimorph piezoelectric bender actuator applied to modulate strain in an optical cable, in accordance with an embodiment of the present invention;

FIG. 22 is a schematic side view of a twisting coupler comprising an electro-acoustic transducer applied to modulate strain in an optical cable, in accordance with an embodiment of the present invention;

FIG. 23 is a schematic block diagram of a coupler unit, in accordance with an embodiment of the present invention;

FIG. 24 is an equivalent electrical circuit of an energy supply system configured to drive coupler units, in accordance with an embodiment of the present invention.

### DETAILED DESCRIPTION OF EMBODIMENTS

### Overview

A fiber optic that carries light having a wavelength of ˜1.5 micrometer is sensitive to even minute strains on the order of sub micrometers. It is therefore an intention of this disclosure to disclose sensing systems comprising coupler designs that induce direct strains in the fiber optic. The resulting strain modulates the phase of an optical carrier wave which propagates in the fiber. The information modulated onto the phase of the optical carrier by the coupler in this manner can be detected at a processing and control unit coupled to the fiber, e.g., using optical phase detection and demodulation techniques.

Some embodiments of the present invention provide systems and methods aiming at increasing a rate at which one or more optical fibers are optically interrogated. Such embodiments further provide systems and methods to enable increased operation frequencies of the couplers, so as to achieve sensing that is (a) less susceptible to noises, and (b) done at increased coupler bandwidths. Increased coupler bandwidth allows coupling of sensed signal frequencies which without the disclosed solution, when coupled to a fiber, have degrading effect due to bandwidth limitations of the system, such that may arise when the fibers are very long.

To increase interrogation rate, reduce susceptibly to noises and increase bandwidth of sensed signal, some of the disclosed embodiments utilize frequency division multiplexing (FDM) at two different frequency bands, or use optical time division multiplexing (OTDM).

An optical FDM (OFDM) process refers to a frequency shift of an optical carrier frequency optical pulse that is launched into the fiber, whereas an electrical FDM process refers to an acoustic modulation of an electrically generated acoustical carrier frequency, to encode data in the frequency domain in such a way that each sensor frequency is transmitted independently and hence can represent an independent bitstream channel In an embodiment, OFDM is implemented by multiplexing optical pulses having slightly (e.g., different carrier frequencies (e.g., pulses separated with center wavelengths separated each of the other by several nanometers about a wavelength of ˜1.5 micrometer).

In another embodiment, OTDM is implemented by multiplexing on different fibers optical pulses having a same carrier frequency and controlling a relative time between a train of pulses at between different fibers to increase interrogation rate and sensing bandwidth.

Disclosed embodiments deal with the challenge of collecting the sensor-generated data deployed along fiber cables without the need for fiber splicing and connectors. These techniques increase the working fiber optic cable length, increase information rate, and reduce error rate. This disclosure further discloses new embodiments regarding the construction of the sensor coupler, and related modulation/demodulation techniques of the data generated by the sensors.

Some embodiments of the present invention that are described herein provide improved methods, devices, and systems to electro-acoustically couple data acquired by one or more sensors onto an optical carrier that traverses an optical cable. The disclosed techniques can be used in a wide variety of systems and applications that involve collecting data from sensors. Embodiments of the present invention further provide improved fiber optic cable sensor-couplers and corresponding optical interrogators. In some embodiments, the system comprises an optical interrogator (also referred to as a “main control unit,” “main unit”), fiber optic cable, and a plurality of sensor couplers that are deployed along the fiber optic cable. In some embodiments, the main unit comprises control functionalities and is further configured, as a controller, to coordinate and send the configuration parameters to the multiple couplers.

Various sensors may be deployed along the fiber optic cable.

The disclosed system, namely the interrogator unit and the data coupling unit, may operate with the sensors in two main operation modes:

1) Transmission mode.

2) Reflection mode.

Each mode takes advantage of its unique physical implementation.

In some embodiments, an optical cable serves as a common communication bus for connecting multiple sensors to a control unit. The sensors are coupled to the optical cable using multiple coupler units, with each coupler unit configured to (i) accept one or more configuration parameters, (ii) receive data from one or more sensors, (iii) modulate the data onto an acoustical signal in accordance with the configuration parameters, and (iv) modulate a mechanical strain applied to the optical cable with the acoustic signal, so as to modulate the optical signal with the data. Further provided is a detector, which is configured to receive the optical signal from the optical cable, and to demodulate the data that was modulated onto the optical signal by the multiple couplers, and a main unit, which is configured to perform the optical interrogation. When the main unit comprises control functionalities it is named also “controller.” In the absence of such control functionalities, each of the multiple coupler is typically configured (e.g., before deployment) with a given set of configuration parameters.

An example of methods, devices, and systems for coupling data acquired by one or more sensors onto an optical carrier that traverses an optical cable using electro-acoustic transducers, is described in International Patent Application PCT/IB2017/053833, filed Jun. 27, 2017, entitled “Coupling Sensor Information To an Optical Cable Using Ultrasonic Vibrations,” which is assigned to the assignee of the present patent application and whose disclosure is incorporated herein by reference.

In some embodiments, the couplers are configured to harvest electrical power by induction from an electrical conductor that runs along the optical cable. In some embodiments, two or more optical reflectors are inserted at predefined locations along the optical cable, wherein the optical source is configured to generate the optical signal such that reflections of the optical signal from the optical reflectors do not overlap when reaching the detector.

The aforementioned configuration parameters for a given coupler unit may include a center frequency allocated to the acoustic signal of the given coupler unit, and the given coupler unit may be configured to generate the acoustic signal having the allocated center frequency. The configuration parameters for a given coupler unit typically include a bandwidth allocated to the acoustic signal of the given coupler unit, and the given coupler unit is configured to modulate the data onto the acoustical signal while not exceeding the allocated bandwidth. In an embodiment, the configuration parameters for a given coupler unit comprise relative power levels to be set at respective frequencies within a bandwidth of the acoustic signal.

In some embodiments, the controller is configured to send an instruction to switch to a “listen only” mode to a given coupler unit. The given coupler unit is configured, upon receiving the instruction, to refrain from modulating the mechanical strain.

In other embodiments, in response to a request from a given coupler unit, the controller is configured to assign an increased bandwidth to the given coupler unit for a defined time slot by modifying the configuration parameters, and to instruct one or more of the other coupler devices to switch to a “listen only” mode during the defined time slot. The controller may be configured to assign respective addresses to the coupler units, and to send the addresses to the coupler units. The controller may be further configured to initiate assignment of the addresses by sending a broadcast message. In response to the broadcast message, each coupler unit is configured to randomly select a respective carrier frequency for the acoustic signal, and to modulate the mechanical strain applied to the optical cable with the acoustic signal having the randomly-selected center frequency. The controller is configured to assign each address to a respective randomly-selected center frequency, and to notify the coupler units of the address assigned to each randomly selected center frequency. Each coupler is device-configured to adopt the address that is assigned to the randomly selected center frequency of the coupler.

In some embodiments, the controller is configured to detect that two or more coupler units have randomly selected a same center frequency, and, in response, to instruct the two or more coupler units to randomly select a center frequency again. The controller is further configured to detect that two or more coupler units have randomly selected the same center frequency by failing to demodulate the data on a given center frequency. Moreover, the controller is configured to detect that two or more coupler units have randomly selected the same center frequency by detecting that the number of the center frequencies is smaller than the number of the coupler units in the system.

In an embodiment, the controller and a given coupler unit are configured to perform a closed-loop equalization process that equalizes a phase change across a bandwidth of the acoustic signal of the given coupler unit.

Further described are embodiments of mechanical elements of an apparatus of a coupler unit, which is configured to apply the acoustic modulation to the optical cable. In the disclosed embodiments, such an apparatus includes (a) an acoustic transducer, which is coupled to an optical cable and is configured to modulate a mechanical strain applied to the optical cable with an acoustic signal, so as to modulate an optical signal traversing the optical cable with data, and (b) a mechanical element that is configured to apply a returning force to the optical cable that opposes the mechanical strain applied by the acoustic transducer.

By providing OFDM and OTDM methods combined with electrical FDM methods, and by providing a configurable and auto-adjustable system comprising multiple sensors that are electro-acoustically coupled to transmit data over an optical cable, the disclosed technique may improve autonomous sensing capabilities of sensing system deployed, for example, in extreme ambient environments.

### System Description

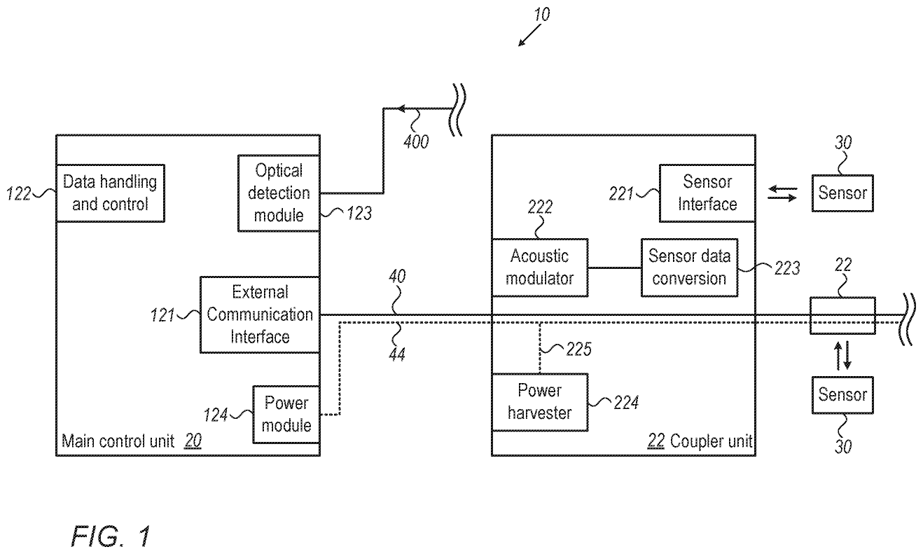

FIG. 1 is a block diagram that schematically illustrates a sensor system 10, in accordance with an embodiment of the present invention. Systems such as system 10 can be used in any suitable field or application that involves data collection from sensors. Several non-limiting examples include networks of perimeter intrusion detection sensors, transportation-related sensor systems such as along railways, roads or tunnels, energy-related sensor networks such as in power stations, oil rigs or gas fields, and/or geophone sensor networks used in seismology, to name just a few.

System 10 comprises one or more coupler units 22 to couple sensors 30 that sense suitable parameters to an optical cable 40. The sensors may comprise, for example, geophones, microphones, hydrophones, temperature sensors, gas- or other chemical-detectors, magnetic field sensors, low-rate video cameras, thermal imaging devices, or any other suitable type of sensor. A given sensor may sense any suitable parameter, e.g., vibration, temperature, pressure, humidity, salinity, nuclear radiation, electromagnetic field, motion, space detection, or any other suitable parameter. System 10 may couple any desired number of sensors, e.g., several dozens, possibly of multiple different types.

Each coupler unit 22 uses a power harvester module 224 to receive electrical power, for example, by induction (225). Each coupler unit 22 further includes a sensor interface 221 for a sensor 30. Sensor data is converted (e.g., digitized) in a sensor data conversion module 223, wherein sensing signals modulate the carrier wave in a fiber 40 using acoustic modulator 222, as described below.

Coupler units 22 modulate data derived from the outputs of the sensors onto an optical carrier that traverses optical cable 40. The structure and functionality of electro-acoustic couplers 222 (also called “acoustic modulators”), of which at least one is included in coupler unit 22, are addressed in detail below. In the present example, each coupler unit 22 has a single acoustic modulator 222 that serves a single respective sensor 30. Generally, however, a given coupler unit and its couplers may serve more than one sensor.

Electro-acoustic modulator 222 receives a modulating electrical carrier wave signal as input, and converts the modulating signal into an acoustic wave of a same frequency. The acoustic carrier frequency is in the range of frequencies of modulator 222. When using an ultrasonic transducer, for example, the acoustic carrier frequency is typically on the order of several tens or several hundreds of kHz. Generally, however, the disclosed techniques can be implemented using couplers operating in any other acoustic frequency.

By using different acoustical earlier frequencies, each coupling unit modulates the optical carrier in cable 40 on a different frequency range. This form of Frequency-Domain Multiple-Access (FDMA) multiplexing enables a main control unit 20 to de-multiplex and distinguish between the signals of the different coupling devices. In one example embodiment, different coupler units 22 are assigned carrier frequencies such as 500 kHz, 550 kHz, 600 kHz, etc.

The coupler unit transfers (“couples”) the acoustic wave to a selected section of optical cable 40. In the disclosed embodiments, coupler 222 applies a time-varying longitudinal mechanical strain to the section of optical cable 40, which varies as a function of the acoustic wave produced by coupler 222. The time-varying longitudinal strain thus modulates the data received from sensor 30 onto the optical carrier traversing optical cable 40. Several configurations of couplers that apply longitudinal strain are illustrated below.

In the embodiment of FIG. 1, the electrical power for operating units 22 is harvested from an AC power signal that is applied by main control unit 20 to an electrical conductor 44 running along cable 40. In the present example, power-harvesting coil circuit 224 is inductively coupled to the electrical conductor in cable 40 using a coil. For example, the coil may be wound around cable 40, and the AC power signal inducts an AC voltage in the coil.

In some embodiments, electrical conductor 44 is also used to send information from main control unit 20 to sensors 30 and/or to coupling units 22. In an example embodiment, main control unit 20 modulates this information on the AC power signal that is applied to the electrical conductor. Any suitable analog or digital modulation scheme can be used.

In various embodiments, any suitable type of information may be sent from main control unit 20 to units 22 and/or sensors 30. Example information may comprise configuration instructions to units 22, e.g., assigned carrier frequencies or on/off commands. Additionally or alternatively, the information may comprise instructions for sensors 30, e.g., camera-steering instructions, steering instructions for a motion detection sensor or any other directional sensor, and/or on/off commands. As yet another example, the information may comprise a request to a given sensor or coupling device to provide data (e.g., sensor readout). A given item of information may be addressed to a single recipient (coupling device or sensor) or to a group of recipients.

Main control unit 20 of system 10 comprises an external communication interface 121, for example for transmitting configuration parameters to a given coupler unit 22 via a communication port of the interface, as well as transmitting the carrier wave via an optical port of the interface. Interface 121 transmits the un-modulated optical carrier into one end of a selected optical fiber in cable 40, and receives the modulated optical earlier from optical fiber 41.

Control unit 20 further comprises a data-handling and control unit 122, an optical detection module 123 to detect modulated signals from coupler units 22, and a power module 124 to supply power to coupler units 22 over a conductor 44, as described below.

In some embodiments, control unit 20 further comprises a processor that manages the operation of system 10. The processor may, for example, output the demodulated data to a host and/or perform any other suitable computing or management task.

In the shown embodiment, system 10 operates in closed loop control using the following method: coupling device 22 transfers its data to main control unit 20 through strain perturbations on optical cable 40 which are received as modulated signals over a return cable section 400 of cable 40 and read by the main unit using optical detection module 123 that applies a coherent phase detection process. Protocol. level. commands are sent from control unit 20 to a specific coupler unit address and a response at a protocol level, such as a header for internal communication, is transmitted from coupler unit 22 back to control unit 20. The main control unit distinguishes between “sensor data” and “internal info,” both transferred from the coupler, in the same manner, by a communication protocol.

In this embodiment, interface 121 transmits the un-modulated optical carrier into one optical fiber running in cable 40, and receives the modulated optical carrier from another optical fiber running in cable section 400. The two fiber sections are connected with a suitable loopback connection at the far end of the optical cable. In another embodiment (not shown), interface 121 transmits the un-modulated optical carrier into one optical fiber running in cable 40, and receives the modulated optical carrier from the same optical fiber running in cable 40. In this embodiment the fiber is terminated with a mirror at its far end.

The different elements of coupler units may be implemented using suitable hardware, such as using discrete components, one or more Application-Specific Integrated Circuits (ASICs) or Field-Programmable Gate Arrays (FPGAs), or in any other suitable way. In some embodiments, some elements of the coupling unit may be implemented using software, or using a combination of hardware and software elements. Elements of the coupling unit that are not mandatory for understanding the disclosed techniques have been omitted from the figure for the sake of clarity.

### Transmission and Reflection Modes

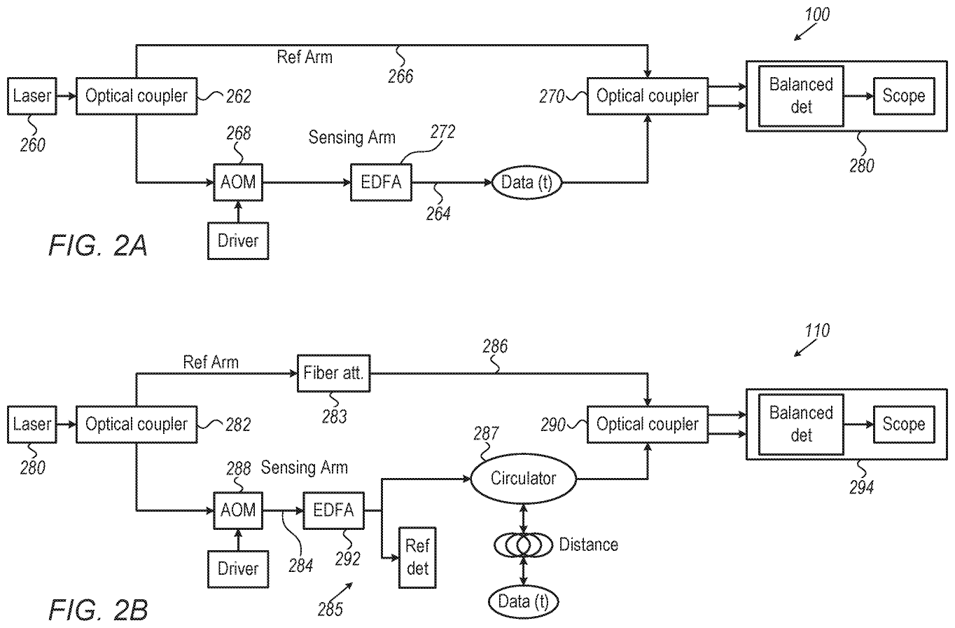

FIGS. 2A and 2B are sensor systems 110 and 110 configured to operate in transmission and reflection modes, respectively, in accordance with embodiments of the present invention.

In transmission mode shown by FIG. 2A, the detected light is not reflected back from the fiber, such as inside cable 40 of FIG. 1, but rather goes through it. Carrier light waves emitted from a laser propagate through the entire fiber length, and is electro-optically coupled (270) to a detection unit (280) at the opposite end of the fiber.

In this embodiment, a laser source 260 is set to CW mode at a wavelength of 1.55 μm, the laser's output optical power is divided (262) unequally between the system's two aims: the sensing arm 264, where the coupler units (e.g., units 22) are connected, and the reference arm which serves as the local oscillator (LO). The acousto-optic modulator (AOM) 268 (such as AOM 222 of FIG. 1) causes a constant frequency shift in the light that goes through the sensing fiber, which is later used for the heterodyne detection process. The light that exits the AOM is then amplified using a conventional EDFA 272 and then launched to fiber 264. The coupling unit can be connected anywhere along the fiber. At the end of the fiber the light from the sensing arm is interfered (e.g., mixed) with the light from the reference arm, and the resulting signal is detected by the balanced detector. The detector output is a fixed-frequency signal, corresponding to the AOM frequency shift, with a phase that contains the perturbations occurring along the fiber. The phase can be extracted, e.g., by using conventional coherent detection methods.

Since the perturbation strain is typically linearly related to the modified optical phase, the coupling unit essentially modulates the sensor's data using accurate strain perturbations, and the detection unit extracts the data from the optical wave phase. Essentially this means that the system bandwidth is limited by the coupler frequency response which, in practice, can reach hundreds of kHz.

In reflection mode shown by FIG. 2B, the detection process is based on a coherent optical time-domain reflectometry (OTDR) method. A laser 280 output light wave is launched into fiber splitter 282 which splits the input power to two different paths: the sensing arm 284, with receives most of the optical power, and a reference arm 286 where the rest of power is sent, and where the light is further attenuated (283). The light in the sensing arm goes through an AOM 288 which outputs a pulse of light in the desired temporal length and blocks the light outside this window. The ratio between the transmitted optical power and the light that passes in the blocked time is called the extinction ratio, which is about 40 dB in the shown system. The pulse is then amplified using an optical amplifier (EDFA) 292. For control purposes, a tapping (285) is made on the pulse temporal shape right after the EDFA. The amplified pulse, with a typical maximum instantaneous power of 20 dBm, is launched to a circulator 287 which, in turn, passes the light to fiber 284. The optical backscattered light from fiber 284 goes back to the circulator which now turns it to an optical coupler 290. The optical coupler has one input with the Rayleigh backscattered light and a second input with the light coming from reference arm 286. The two outputs of the optical coupler are electro-optically coupled to a detection unit 294 comprising a balanced detector which outputs electrical signals to a sampling scope for analysis.

### Frequency Allocation Process

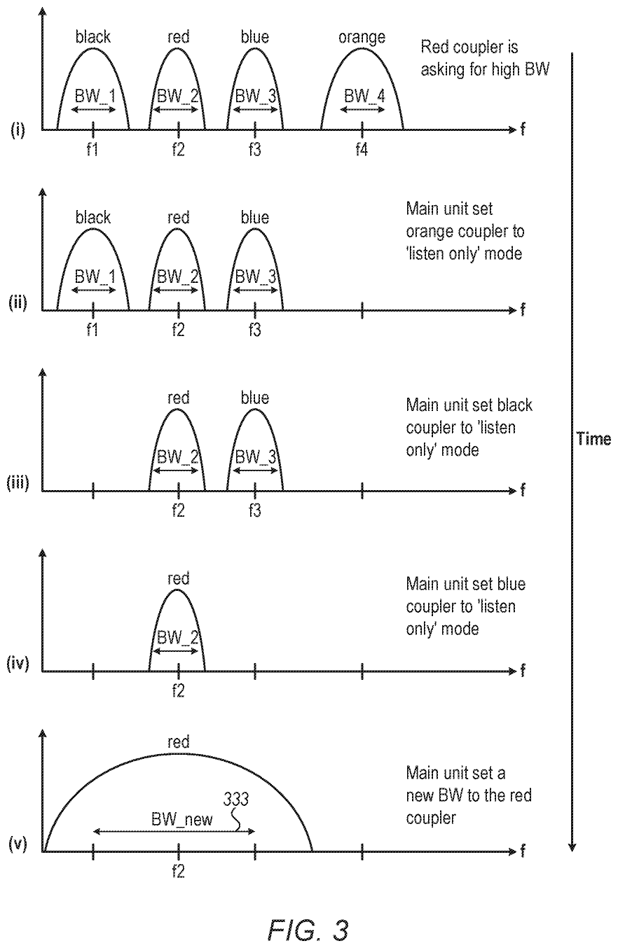

FIG. 3 is a graph schematically showing a process of frequency allocation among the coupler units of system 10 of FIG. 1, in accordance with an embodiment of the present invention. The description is applicable to either a system operating in transmission mode (e.g., system 100) or to a system operating in reflection mode (e.g., system 110).

For communicating with the couplers over the above-described physical channels (e.g., over a metallic armoring layer of the optical cable), systems 100 and 110 allocate both a center frequency and a bandwidth (BW) to each coupler unit, such as unit 22. Where a coupler unit serves multiple sensors, multiple center frequencies and a bandwidth are allocated to the coupler unit. All coupler units have the same design and can operate at any suitable (e.g., legal) ultrasonic frequency. The frequency allocation process can be done upon installation. Each coupler unit has its own unique address and thus can be addressed separately by the main control unit (also called “the interrogator”). The main control unit approaches an individual coupler unit and sets its main frequency and allowed BW. To guarantee that there is no spectral overlap between different coupler units, the allocation is managed by the same control unit. The optical phase spectrum after detection and the couplers' uploaded data, for example in a four-coupler system, is illustrated in FIG. 3 line (i).

In some cases, a high BW is needed by one of the sensors. In this case the respective coupler unit requests a high BW time slot through the regular communication protocol from the main control unit. In some cases, the main control unit will then reply to all of the other couplers, one at a time using their address, and set them to “listen only” mode. In this mode, the main unit instructs a coupler to stop transmitting data. The coupler ignores any information coming from the sensors. The coupler power-harvesting is still on, and thus the commands from the main unit to the coupler are still received, which is addressed as “listen only” mode.

Then the main unit approaches the coupler that requested the high BW time slot and sets it to this mode by changing its allowed BW (and possibly its central frequency). The process is illustrated in FIG. 3 lines (i)-(v). As seen, one after the other (or at a same time), coupler units working at carrier frequencies f₁, f₃ and f₄, enter listen mode, and the coupler unit working at carrier frequencies f2 receives the required high BW 333.

### Coupler Unit Addresses and Position Allocation

The process of address allocation to a coupler unit is applicable to either a system operating in transmission mode (e.g., system 100) or to a system operating in reflection mode (e.g., system 110).

In most embodiments, the main control unit communicates to the coupler units commands and parameters, among other data types, via the power transfer layer. The main control unit uses a broadcast channel in the communication process. In order to communicate to a specific coupler unit, the control unit must use a unique address per coupler.

The address allocation process can be done in two ways:

### (a) Predetermined Address Allocation

In the predetermined address allocation method, each coupler unit has a unique address known to the main control unit and to the coupler unit itself before system installation. The coupler reacts only to commands (from the main control unit) that contain its address in a header.

### (b) Dynamic Address Allocation

In the dynamic address allocation method, the coupler unit acquires a unique address after/during system installation. The main control unit sends a broadcast message asking for a reply, and each coupler responds by transmitting a random constant frequency. Since the transmission can be made relatively long, it means that the frequency resolution can be made sufficiently high to allow for multiple addresses. The main control unit then sends a broadcast message allocating address by frequency, meaning that the main control unit gives an address per frequency. Since each coupler knows the frequency it transmitted, it now knows its own address and stores it in its internal memory.

A broadcast message can be interpreted as in the following Table 1:

TABLE 1

| | | |
|---|---|---|
| New line | Frequency #1 | Address #1 |
| New line | Frequency #2 | Address #2 |
| New line | Frequency #3 | Address #3 |
| New line | Frequency #4 | Address #4 |
| New line | Frequency #5 | Address #5 |

After the address allocation process has ended, the system begins a handshake process with each coupler unit individually. The main control unit asks for the coupler unit with address #1 to respond with its new address, and continues in a similar manner with the other coupler units.

A rare event, in which two or more couplers are given the same address, causes one coupler reply message to interfere with a reply from another coupler, creating a noisy pattern. The main control unit then sends a message to this “problematic” address asking it to repeat the allocation process. In response, the coupler units randomly choose a new frequency to transmit and store it in their internal memory instead of the previous one. The probability of collision decreases significantly, since the number of units participating in this random process is much lower than in the initial process (typically a few units, compared to the entire number of couplers on the line). The process ends after each coupler has its own unique address and has made a successful handshake with the main control unit.

Finally, the positions of the coupling units along the fiber can be learned after installation by the system. The main unit learning process can be implemented as follows: all of the couplers begin with a single frequency transmission. The main unit starts searching for this specific frequency, which is known to it, along the fiber. After the search has ended the system stores the coupler locations in its internal memory.

The main unit can always trigger this process again for internal needs, such as updating/changing coupler location, adding a new coupler, pulling down a coupler, and others.

### Frequency Division and Multiplexing

The disclosed systems implemented in reflection mode are based on the principles of coherent OTDR systems. Common OTDR systems have a traditional interrogation rate limit. Without any special means, the “sampling” rate, i.e. the rate of the interrogator pulses launched to the fiber, is limited by the fiber length. The round-trip time for the light to reach the end of the fiber and then return to the detector is the minimal period time between the interrogator pulses.

Since the coupling unit has a frequency response in the range of tens of kHz, the system has better performance in this range. To increase sampling rate, the disclosed reflection-mode systems frequency-modulate the interrogator pulses, and in this way overcome the above-described sampling rate barrier (i.e., by interrogating all of the coupler units every single round-trip time, T, using frequency division).

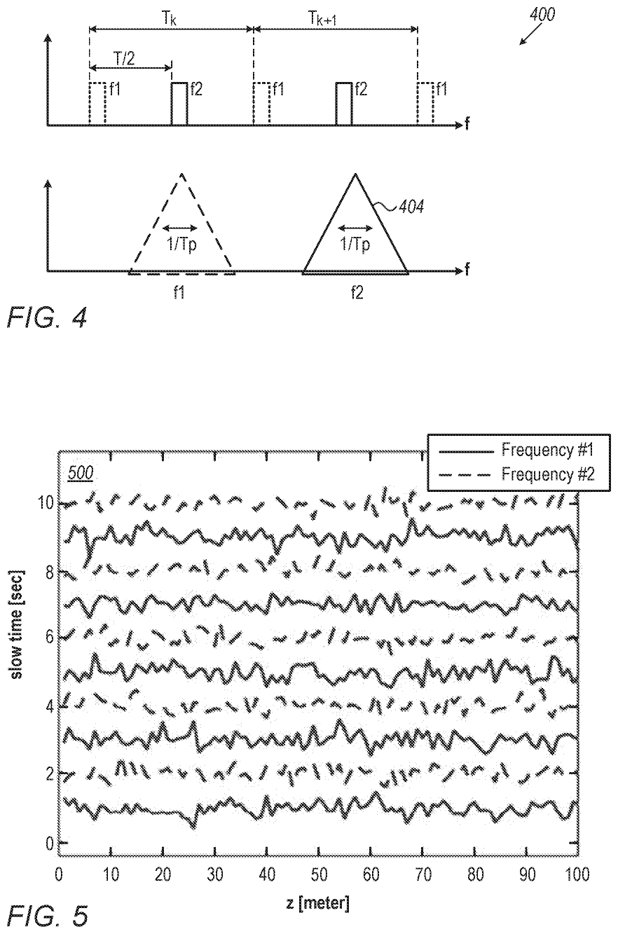

FIG. 4 is a graph schematically showing the expected spectral response (404) to detected optical-frequency-divided signals (400), in accordance with an embodiment of the present invention.

The system alters the RF frequency shift of an optical carrier wave frequency that the AOM shifts every T/N seconds using its driver, where N is determined by the number of the pulse's spectral width multiplication inserted in the modulator's frequency range and T is the round trip duration. The result is N pulses transmitted into the fiber in a period time of T, which effectively yields a pulse repetition rate of N*Fⱼ (see FIG. 4 for N=2 example, j=1, 2). At the detection phase, the different pulses are separated with bandpass filters (BPF), each centered at a different RF frequency according to the modulator's frequency shift (see FIG. 4 for the expected spectral response of the detected signal).

FIG. 5 is a graph schematically showing an incorporation of Rayleigh backscatter pattern (500) of the frequency divided signals, in accordance with an embodiment of the present invention. Each BPF output is analyzed individually, and the event's location along the fiber is extracted using a time of flight (TOF) method. The different Rayleigh backscatter patterns (differing by their carrier frequencies) are interlaced in order to achieve a higher sampling rate of each point along the fiber (see FIG. 5 for an expected interlace outcome).

### Fiber Division Multiplexing

Increasing the sampling rate of the aforementioned fiber using frequency division multiplexing is limited by the AOM frequency range. A state of the art variable AOM has tens of MHz of frequency shift, and since a pulse spectral width without any special compression techniques is on the order of 10-30 MHz, an AOM with a frequency change rate of 60 MHz produces between two to six different frequency-shifted pulses, and thus multiplies the sampling range by this factor only. In order to increase the factor, some embodiments of the disclosed invention use multiple fibers.

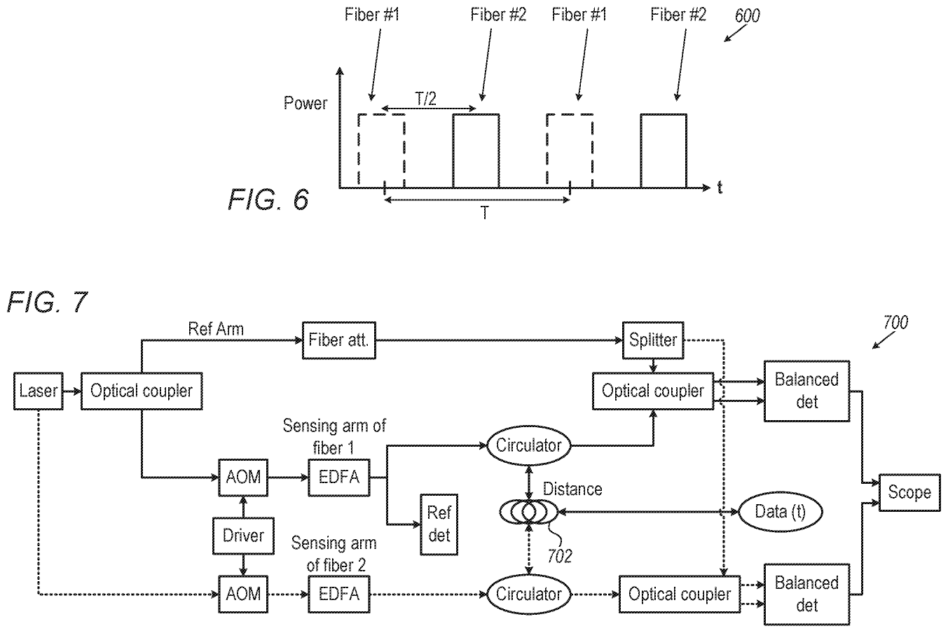

FIG. 6 is a graph schematically showing fiber-divided signals (600) according to frequency, in accordance with an embodiment of the present invention.

Using OTDR with a single fiber is more readily possible, because it is easier to apply strain on a fiber rather than on a shielded optical cable comprising multiple fibers. Some of the disclosed systems are designed to mechanically connect to optical cables rather than optical fiber, i.e., to operate sensors on several fibers at the same time and the same position.

For example, the scanning rate can be doubled for each additional fiber used by the disclosed system. The disclosed system is designed so it will upload any kind of data from any kind of sensor along the fiber and download this information at the main control unit. The upload/download process takes place on the light passing through one specific fiber, i.e., the fiber that is connected to the main control unit. The other fibers inside the optical cable are not affected by this process and can be used for regular non-coherent optical communication. The BW can be increased at the expense of additional fibers. Redirecting fibers to the main control unit results in fewer fibers for other communication purposes, but greater BW for the OUSB system, as the fibers inside the optical cable are finite and serve more than on user/customer.

In such a technique, therefore, the pulses that are transmitted into the fibers are now divided in the time domain but can be carried by the same central frequency. An example of the principle can be seen in FIG. 6. The pulses labeled “fiber #1” are transmitted into fiber #1 with repetition rate of 1/T, corresponding to the round-trip duration inside the fiber. The pulses labeled “fiber #2” are transmitted in the same rate to fiber #2. Since both fibers are placed in the same optical cable, the data coupling unit is connected to them in the same spatial position.

Though the strain perturbation (of the coupler) does not affect the fibers equally in terms of physical deformation, it has a linear effect on the optical phase inside each one of the fibers. The data coming from fiber #1 is interlaced with the data coming from fiber #2 in order to create a double information sampling rate.

### OFDM and OTDM

FIG. 7 is a sensor system 700 configured to operate in reflection mode and having two sensing fibers multiplexed according to the scheme of FIG. 4, in accordance with an embodiment of the present invention.

The solid lines represent one fiber inside the optical cable, referred to as “fiber 1,” and the dashed lines represent a second optical fiber inside the cable, which is referred to as “fiber 2,” A double line represents RF cables. Loop 702 represents the common optical cable wherein lie the two fibers. The two sensing fibers share the same driver for their modulators, the same reference light source, the same sampling unit, and the same light source. However, each AOM generate different carrier frequency and hence by interleaving the pulses from the first AOM, with the pulses of the second AOM, the system generates a combined train of pulses comprising two carrier frequencies. Using frequency multiplexing in general (the aforementioned OFDM), and in particular by using two or more AOMs, results in higher sampling (i.e., interrogation) rate, as seen in FIG. 5.

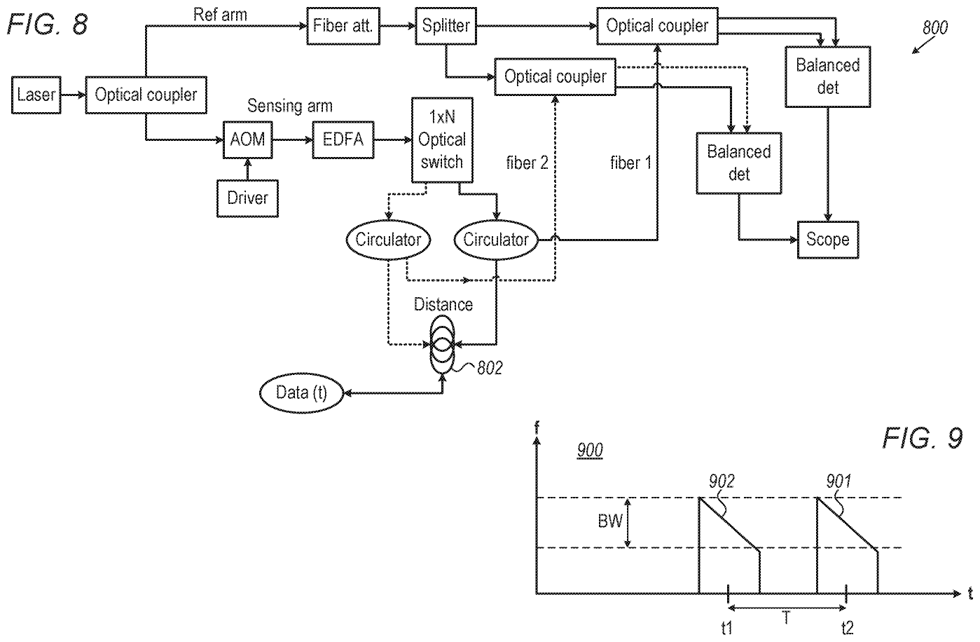

FIG. 8 is a sensor system 800 configured to operate in reflection mode and having two sensing fibers multiplexed according to the scheme of FIG. 6, in accordance with another embodiment of the present invention. As seen, system 800, which has a configuration for the same two-fiber (“fiber 1” and “fiber 2”) division method as system 700, alternatively uses a switch 802.

In the configuration of FIG. 8, the two sensing fibers share the laser, modulator, optical amplifier, and sampling scope. As before, loop 802 represents the optical cable containing all of the optical fibers. In this method the pulse rate leaving the modulator is doubled for each additional fiber added to the system comparing to the pulse rate required for a single fiber sensing operation.

A third implementation option for this method (not shown) is the use of different lasers, each at a different wavelength. In this case each laser is connected to a different sensing fiber inside the optical cable, and therefore different references are needed, as each fiber holds its own reference arm with its unique wavelength.

The system configurations shown in FIGS. 1, 2A, 2B, 7, and 8, and the coupling unit configuration shown in FIG. 1, are example configurations that are chosen purely for the sake of conceptual clarity. In alternative embodiments, any other suitable system and/or coupling device configuration can be used.

Chirped Interrogator Pulse

FIG. 9 is a graph 900 that schematically shows linear frequency modulated (LFM) pulses (901, 902 . . . ) that are used by the systems as interrogator pulses to increase allocated bandwidth (BW), in accordance with an embodiment of the present invention. As an example, as shown in FIG. 9, two consecutive pulses (901, 902) correspond to consecutive samples transmitted on a fiber of a sensing arm of a system such as systems 100 and 110.

In some embodiments, by using LFM pulses as the interrogator pulses, the system can have an increased spatial resolution, i.e. reduce a spatial cell length per sensor. The LFM method can be implemented with more than one RF carrier frequency and thus can be used with the frequency multiplexing method. The LFM method can be thus implemented along with frequency division multiplexing or with a single interrogation pulse.

To generate LFM pulses, the interrogator pulse goes through LFM, by AOM of EOM, before being launched to the fiber. After the regular coherent detection process, the signal is convolved with a matched filter (MF) in order to compress it in the time domain. The result is a high BW pulse with a relatively long temporal duration.

### Code Sequence Compression

Long range applications require the use of high optical power pulses. The maximal instantaneous power that a fiber can handle, before any non-linear phenomena appear, sets the upper boundary for the transmitted power. Extending the pulse width to reduce peak power results in poor spatial resolution. In some embodiments, periodic coherent codes are used by the system in order to overcome the power limit.

The output laser light is externally modulated by a perfect periodic sequence using an optical modulator (usually EOM). Thus, light is constantly transmitted into the fiber without any “dead times,” as in the single pulse case. The back reflected light is detected and auto-correlated with the basic code sequence to create the fiber profile. The result is a fiber trace with the equivalent of high spatial resolution, while the overall transmitted power is greater than the single pulse option.

### High Fidelity Mode Using Polarization Maintain Fibers

In some embodiments, the systems use polarization maintain (PM) fibers inside the optical cable for applications that require high fidelity. In this mode, the main control unit transmits pulses at a higher rate, while a polarization switch is responsible for passing consecutive pulses at perpendicular polarizations corresponding to the fiber's principle axis.

In this method the coupling unit coupler, which remains the same, is sampled twice every T seconds, and every sample is then averaged between the two different polarizations, and thus the sampling rate is the same as without using PM fibers. The advantage of this method is that the Rayleigh backscattered light is polarization-dependent, meaning that it can suffer from low reflection in some portion of the fiber while reflecting stray high power. This method samples every point along the fiber with two perpendicular polarizations and thus overcomes the phase ambiguity in the case of low amplitude reflections.

### Equalization Process for Frequency Division Multiplexing (FDM)

A coupling unit can modulate carrier waves by a coupler of the unit (e.g., AOM) oscillating the optical cable at any given frequency in the sonic and/or ultrasonic frequency band, i.e., from few hundred Hz to more than 100 kHz. To modulate a coupler at a given frequency so as to generate a detectable optical signal from the sensed signal, the coupling unit consumes electrical power at a respective AC frequency of a given voltage amplitude. Thus, a request to adjust power at a specific frequency is translated into a request to adjust a driving voltage amplitude at the frequency.

The transmitted data is encoded in the frequency domain so each oscillation frequency represents an independent bitstream link. The main control unit detects the oscillations via the optical phase of the interrogator pulse and interprets each sonic and/or ultrasonic frequency independently. The coupler has discrete frequencies stored for this purpose in its internal memory, and the main control unit holds the same information in its memory, and thus the main unit analyzes only this set of frequencies.

As each frequency represents a different bitstream with equal probability, the system as a whole (coupler unit and main unit) tries to equalize the modified phase change of each frequency so that the bit error rate is minimized. The equalization process uses the closed loop control between the main unit and the coupler unit in order to feedback the coupler's power levels per frequency.

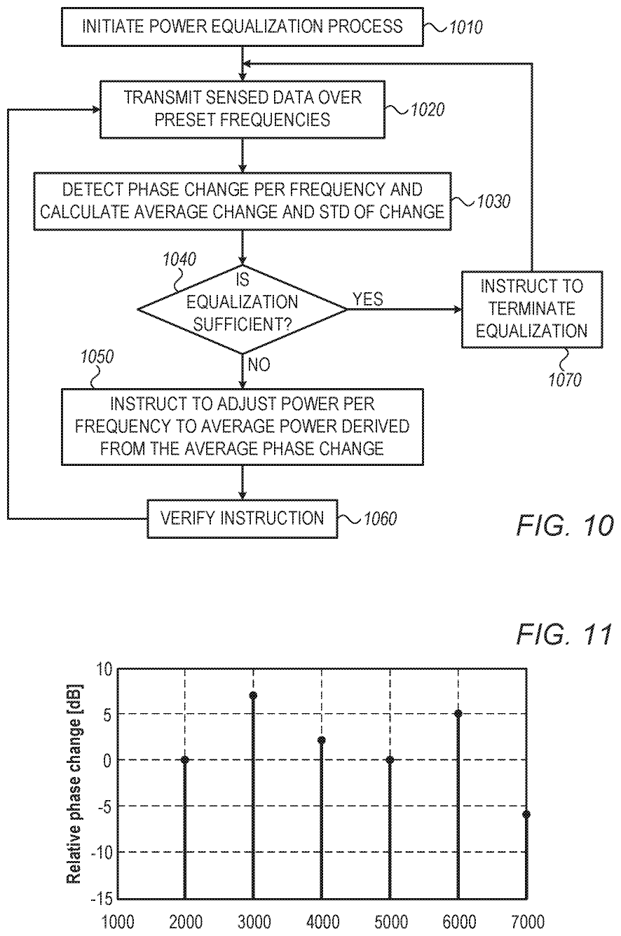

FIG. 10 is a flow chart of a method of power equalization over multiple modulation frequencies, in accordance with an embodiment of the present invention. The process begins with an equalization initialization step 1010, in which the main unit sends a coupler unit a specific message that is agreed, on both parts, as the initiate command. The message has a unique coupler unit address and thus the process is done per coupler unit, but can be done to more than one coupler unit simultaneously.

At a data transmission step 1020, after receiving the “initiate” command, the coupler unit starts transmitting data over discrete frequencies, known to both sides in advance, each for the same duration (T seconds).

At a detection step 1030, the main control unit detects the phase change induced by the coupler unit for each frequency; the result of this process is a table with a set of frequencies and their corresponding phase change. The main control unit then calculates the mean phase change value and its standard deviation, with an example of relative change in phases shown below in FIG. 11.

At a checking step 1040, the main control unit checks whether one or more equalization criteria, such as a standard deviation of the detected phase table below a given value and/or an induced phase level below a preset minimum level, is met.

If not, at a next power adjusting instruction step 1050, the main control unit sends the coupler unit (e.g., via the power link) a message with the required relative power change per frequency. As the set of frequencies is known to both sides, the message does not contain the actual frequency but rather indexed information inside the message packet to indicate to which frequency is being referred. An example of a feedback message is presented in Table 2 below:

TABLE 2

| Bits | 1-8 | 9-16 | 17-24 | 25-32 | 33-40 | 41-48 | 49-56 |
|---|---|---|---|---|---|---|---|
| Power change [dB] | 5 | 0 | −5 | −1 | 0 | −4 | 5 |
| Referred to | f1 | f2 | f3 | f4 | f5 | f6 | f7 |

Note that the message comprises only the second row of the table. The third row is the frequency interpretation of each byte and the first line is based on the indexing of the data in the message packet.

At a power adjusting verification step 1060, upon receiving the first feedback message, the coupler unit and the main control unit perform a handshake process in order to make sure that the message was received properly on the coupler's side, and the coupler repeats step 2 using the adjusted power levels.

The main control unit then repeats steps 1030 to 1050 until one or more equalization criteria are met and the process ends.

If the stopping criteria is met, the main control unit sends a “terminate process” message to the coupler, at a termination step 1070. The coupler stores the latest power levels in its internal memory and continues operation using these power values.

FIG. 11 is a graph schematically showing a detected phase change for each frequency derived by the process of FIG. 10 (at step 1030), in accordance with an embodiment of the present invention. in FIG. 11, in the field, modulation in different frequencies produce different amounts of optically sensed signals in a form of relative phase change, up to 7 dB. while a typical acceptable relative phase variation of the optical signal between different frequencies should be a fraction of a dB. Using the relative phase information, the driving powers are adjusted, as described in FIG. 10, so as to minimize the variation phase shifts shown in FIG. 11.

### Mechanical Coupler Configurations for Applying Strain Modulation

The following description provides example techniques for implementing the mechanical elements of the couplers, e.g., several configurations for generating oscillating strain in the fiber optic. The operation principle is based on a first generating force on the pre-tensed cable, and then, a second returning force that strives to push the cable back in the opposite direction to the generating force. The generating or returning force may be generated by piezoelectric resonators, magnetostrictive materials such as iron, nickel, and cobalt driven by an electromagnetic field, solenoid type actuators, electrostrictive-based actuators, electro hydraulic actuators, etc.

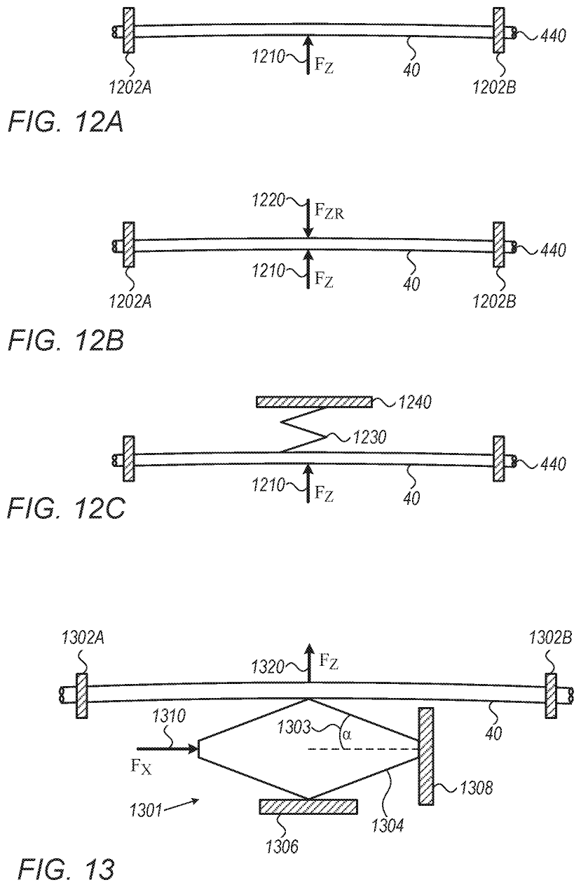

FIGS. 12A-12C are schematic side views of an optical cable 40 strained by forces applied to the cable along a lateral axis of the cable, in accordance with embodiments of the present invention. As seen, a section of cable 40 comprising multiple optical fibers 440 is held between two brackets 1202A and 1202B. In one non-limiting example, the length of the cable section being modulated is on the order of 20 mm, and the radius of cable 40 is on the order of few millimeters. Alternatively, however, other suitable dimensions can be used.

Brackets 102A and 102B are firmly clamped to respective ends of the selected section of optical cable 40, such that they are considered static. The section of cable is typically subjected to a suitable initial longitudinal strain (stretching force) before brackets 1202A and 1202B are tightened.

When perturbed by a suitable modulating force, cable 40 vibrates along a lateral axis (z) of the cable (e.g., along the direction of applied forces).

As seen in FIG. 12A, a force 1210 displaces cable 40 from its stretched resting position. Force 1210 is a time-dependent force, and when it is minimal, a returning force due to cable elasticity acts to bring the cable back to its resting position, and an oscillating motion occurs, with the respective oscillating amount of strain causing the required oscillating phase shift that captures the sensed data at the specific oscillating frequency at which the coupler is driven, among a plurality of driving frequencies.

In the embodiment shown by FIG. 12B, a return force 1220 is applied, where force 1220 is generated by additional means, such as described below. Force 1220 enhances the natural tendency of the fiber to oscillate back (due to elasticity only) and thereby increases a modulation frequency of sensed optical signals and the quality factor of the elastic system. In an embodiment, given by FIG. 12C, force 1220 is provided by a spring 1230 supported by a static base 1240.

FIG. 13 is a schematic side view of a flextural construction 1301 applied to modulate optical cable 40, in accordance with an embodiment of the present invention. As seen, a section of cable 40 is firmly held and stretched between two brackets 1302A and 1302B. Flextural construction 1301 is made of an elastic frame 1304 having a rhomb shape, which is supported by a horizontal base 1306 and a vertical base 1308, against a time dependent longitudinal (i.e., horizontal) force Fx 1310. The shown flextural mechanism converts horizontal vibrations and force Fz generated by a transducer (e.g., modulator), to vertical vibrations and force Fz 1320. Flextural construction 1301 amplifies a vibration amplitude generated by an acoustic transducer, The amplification depends on the angle α 1303.

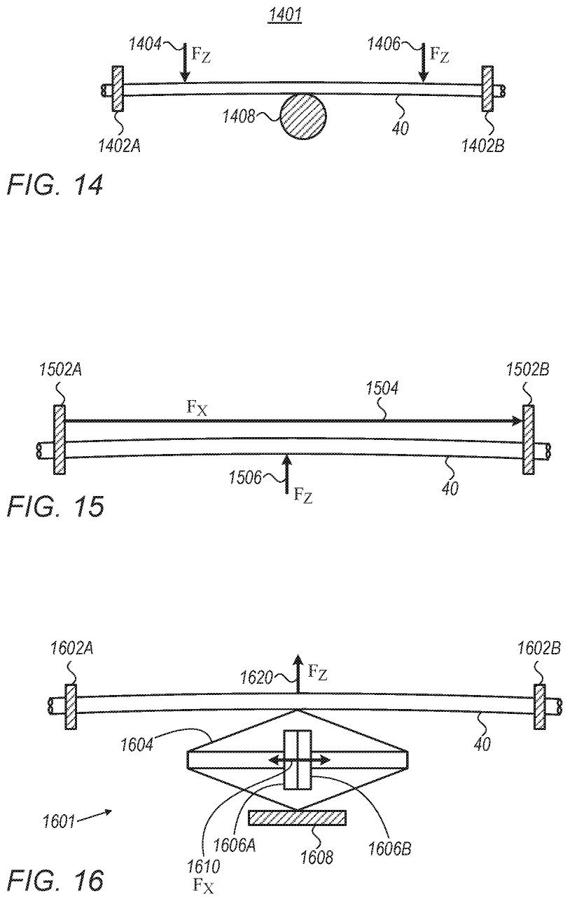

FIG. 14 is a schematic side view of a two-lateral force layout 1401 for generating modulated longitudinal strain to fibers in optical cable 40, in accordance with an embodiment of the present invention. As seen, a section of cable 40 is firmly held and stretched between two brackets 1402A and 1402B. Time-dependent vertical forces 1404 and 1406 are laterally applied against both sides of a static rod 1408 with a circular cross-section, which bends cable 40 and induces, in that way, modulated strain in fibers of cable 40.

FIG. 15 is a schematic side view of a longitudinal-lateral force layout 1501 for generating modulated strain to fibers in optical cable 40, in accordance with an embodiment of the present invention.

As seen, a section of cable 40 is firmly held and stretched between two brackets 1502A and 1502B. A longitudinal force Fx 1504 (e.g., horizontal force in the shown figure) is applied between brackets 1502A and 1502B to stretch cable 40 and induce, in that way, a returning force. A lateral (e.g., vertical in the shown figure) time-dependent force Fz 1506 is applied on cable 40 to generate modulated strain in fibers of cable 40.

FIG. 16 is a schematic side view of a piezo-driven flextural construction 1601 applied to modulate strain in optical cable 40, in accordance with an embodiment of the present invention. As seen, a section of cable 40 is firmly held and stretched between two brackets 1602A and 1602B. Piezo-driven flextural construction 1601 is made of an elastic frame 1604 having a rhomb shape, which is supported by a horizontal base 1308. Time-dependent longitudinal (i.e., horizontal) expanding force Fx 1610 is converted by flextural mechanism 1601 into the required lateral force Fz 1620. As seen, elastic frame 1604 is driven by opposite-facing piezoelectric elements 1606A and 1.606B located within flextural construction 1601 to longitudinally pull elastic frame 1604 from both sides, according to a driving voltage applied in synchrony to the piezoelectric elements.

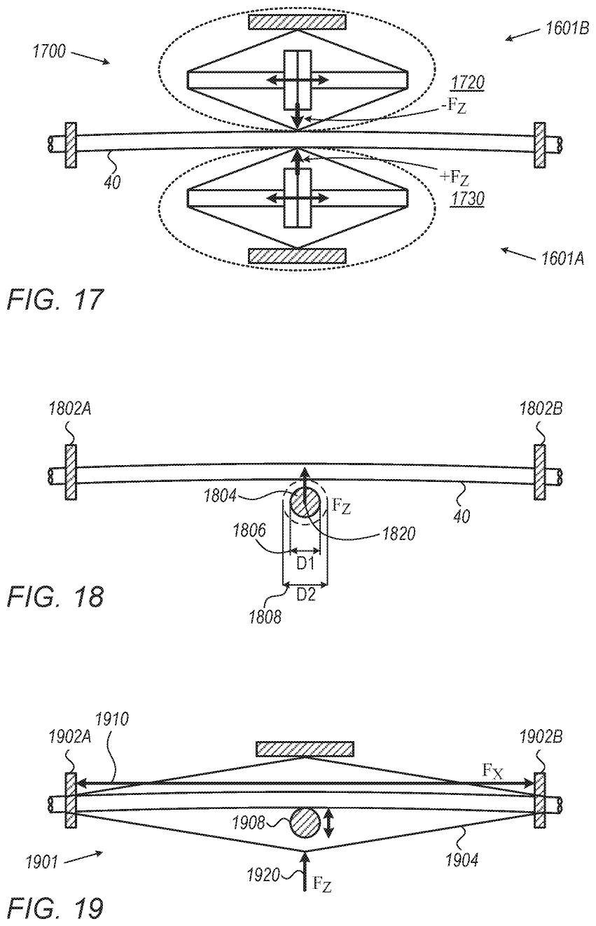

FIG. 17 is a schematic side view of a doubly piezo-driven flextural construction 1700 applied to modulate strain in optical cable 40, in accordance with an embodiment of the present invention. Doubly piezo-driven flextural construction 1700 comprises two laterally opposing flextural constructions 1601 of FIG. 16, to apply, in synchrony, time-dependent lateral forces on cable 40 from two opposing sides of the cable. For this purpose, the two flextural constructions are driven in a synchronized manner in anti-phase. The double layout of FIG. 17 is expected to enhance frequency modulation and the quality factor of the modulation compared with the single layout of FIG. 16.

FIG. 18 is a schematic side view of a circular transducer 1804 applied to modulate strain in optical cable 40, in accordance with an embodiment of the present invention. As seen, a firmly held in place transducer 1804 generates radial vibrations to induce fiber optic strain by applying a time-dependent force 1820. The radial expansion is from a diameter 1806 D1 to a diameter 1808 D2. The returning force may be due to the flexibility of the fiber cable, a spring, or an opposing transducer that works in a synchronized and anti-phase manner.

FIG. 19 is a schematic side view of a return-three flextural construction 1901 applied to modulate strain in optical cable 40, in accordance with an embodiment of the present invention. As seen, a section of cable 40 is firmly held and stretched between two brackets 1902A and 1902B. Return-force flextural construction 1901 is made of an elastic frame 1604 having a rhomb shape, which is fastened to the fiber cable at both ends, using brackets 1902A and 1902B. Elastic frame 1904 is supported by a horizontal base 1306.

In this way, a generated time-dependent lateral force Fx 1920 is transformed by flextural mechanism 1901 into a stretching longitudinal force Fz 1910. Time-dependent vertical force 1910 causes cable 40 to bend against a static rod 1408 with a circular cross-section, and the cable stretches, which induces modulated strain in fibers of cable 40. The flextural mechanism amplifies the vibration amplitude, and a vibration force that generates vibration in the lateral direction Fz generates the required longitudinal strain in the longitudinal direction Fx 1920. The returning force is mainly due to the elasticity of the flextural mechanism. The flextural frame may be composed of titanium, stainless steel, or any other suitable material.

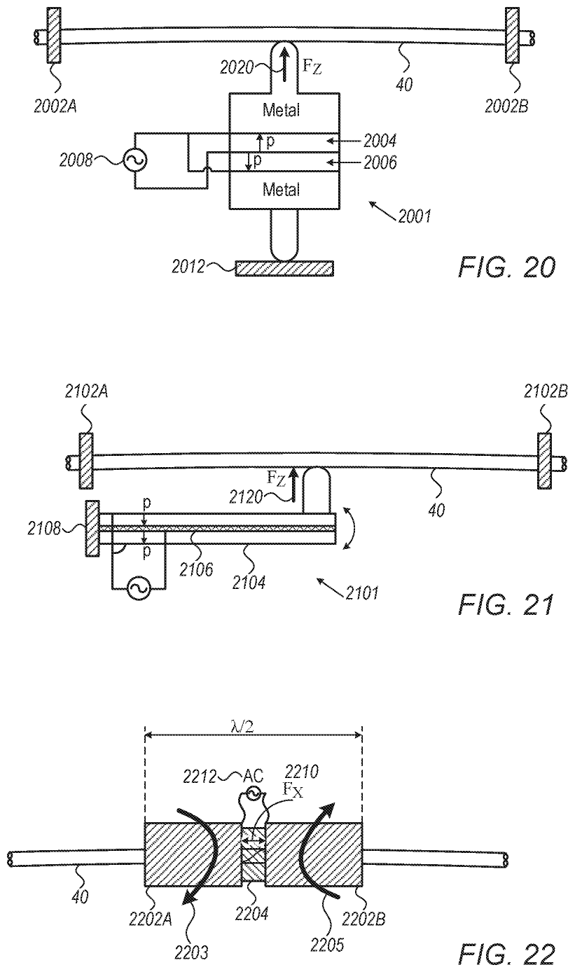

FIG. 20 is a schematic side view of a Langevin piezoelectric transducer 2001 applied to modulate strain in optical cable 40, in accordance with an embodiment of the present invention. As seen, a section of cable 40 is firmly held and stretched between two brackets 2002A and 2002B. Langevin piezoelectric transducer 2001 comprises piezoelectric layers 2004 and 2006 that are driven by an AC voltage source 2008. A horizontal base 2012 keeps the transducer in place and translates the piezo movement into time-dependent stressing force 2020 on the cable section.

FIG. 21 is a schematic side view of a bimorph piezoelectric bender actuator 2101 applied to modulate strain in optical cable 40, in accordance with an embodiment of the present invention. As seen, a section of cable 40 is firmly held and stretched between two brackets 2102A and 2102B. Bender actuator 2101 comprises a beam 2104 that can be bent by piezoelectric layers 2106 that are driven by an AC voltage source 2112. A vertical base 2102 keeps the transducer in place and translates the beam movement into time-dependent stressing force 2120 on the cable section.

FIG. 22 is a schematic side view of a twisting coupler 2201 comprising an electro-acoustic transducer 2204 applied to modulate strain in optical cable 40, in accordance with an embodiment of the present invention. Coupler 2201, as the coupler described above, can be used for implementing an AOM of coupler unit 22 of FIG. 2.

Coupler 2201 comprises two solid parts (e.g., brackets) 2202A and 2202B that are firmly clamped to fiber optic cable 40. During assembly of the coupler on cable 40, left bracket 2202A is slightly turned clockwise (2203), while bracket 2202B is turned counter-clockwise (2205). This pre-distorts (e.g., pre-stretches) a fiber cable 40 section between the brackets, consequently minimizing the mechanical freedom between a fiber inside the cable and the cable envelope. The brackets are then mechanically locked in such a way that the fiber cable section remains stretched.

Being pre-stretched, the cable section may be vibrated in the longitudinal direction (by a force shown as Fx 2210), inducing modulated strain to the fiber optic. Both solid parts (also called “arms”) may be made of linear materials such as metal, or hard plastic such as PEEK. A resonator 2204, which may be a single piezoelectric element or a Langevin resonator, among other examples, is sandwiched between the arms. An AC generator 2212 excites the resonator and causes it to vibrate as shown by Fx 2210. The resonator may be made of hard piezoelectric material. Alternatively, the resonator may be made of a magnetostrictive material such as nickel or Terfenol-D. In the latter case, the AC generator induces a varying magnetic flux within the magnetostrictive material. AC generator 2212 may also excite the resonator at an acoustical frequency which corresponds to a resonance half-wavelength length of a mechanical resonator, as shown in FIG. 22. When driven at its first longitudinal resonance (i.e., at a λ/2), the induced strain may be maximized.

The coupler and transducer configurations shown in the figures above are example configurations that are chosen purely for the sake of conceptual clarity. In alternative embodiments, any other suitable configuration can be used. For example, a configuration similar to that of FIG. 14 can be implemented in FIG. 21 using two bender transducers such as bender 2101 instead of a single bender transducer.

### Coupler Unit Control Block Diagram

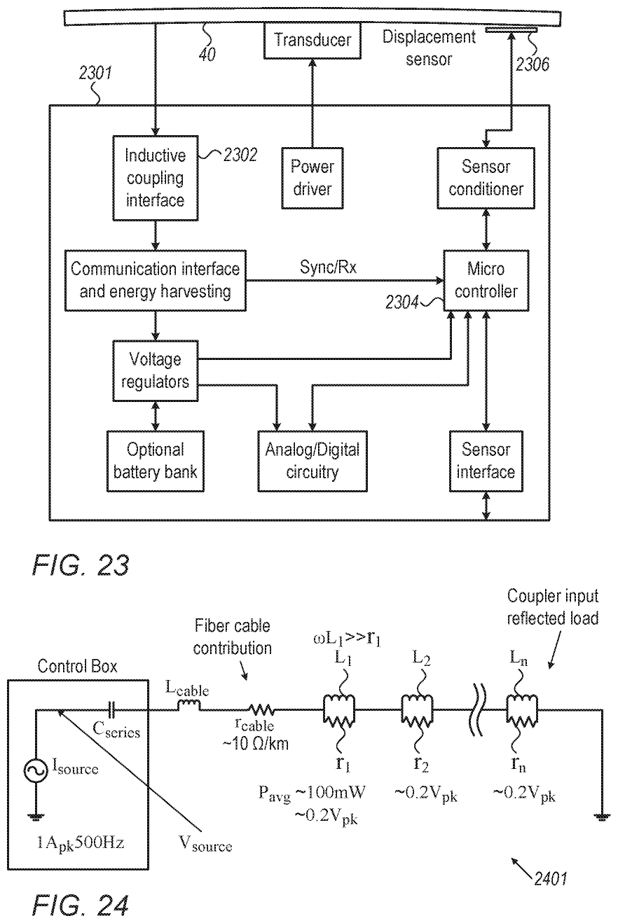

FIG. 23 is a schematic block diagram 2301 of a coupler unit, in accordance with an embodiment of the present invention. FIG. 23 may describe a coupler unit 22 of FIG. 2.

An inductive coupling interface 2302 draws AC current (i.e., harvests power) transmitted through cable 40, using an inductive coupling element, such as a coil (not shown). Typically, the electrical power is transmitted from a main control unit via a metal shield or metal strengthening wire in order to electrically power the deployed coupler.

In some embodiments, interface 2302 comprises power conditioning electronics, and a communication interface which may be similar to a line interface of a power line communication PLC. Interface 2302 may output synchronization. and reply signals to a main control unit, while at the same time output power (received through power harvesting) to feed a voltage regulators of the coupler unit itself The output of the voltage regulators may feed the various control circuitry including the power driver. A micro controller 2304 may be connected to a displacement sensor 2306. The displacement sensor may sense the cable vibration amplitude, and may be based on eddy current sensing, capacitive sensing, or any other suitable technology.

### Energy Harvesting

FIG. 24 is an equivalent electrical circuit of an energy supply system 2401 configured to drive coupler units, in accordance with an embodiment of the present invention.

Typical armored fiber optic cables used for outdoor deployment may have an Ohmic resistance of ˜10 Ω/km. It also has equivalent inductance that depends on its length (ignoring its distributed capacitance that has less effect at low operating frequency). The reactance of the cable may be minimized at the operating frequency by adding a series capacitor that may resonate with the equivalent inductance.

A power source, such as an AC current source, is connected to one end of the metal shield or strengthening metal wire. The electrical circuit is closed either by connecting the other end of the cable metal to the ground (single wire earth return), or by connecting the other cable metal end to the negative terminal of the source. The peak current may be 1 A, and the frequency may be ˜500 Hz. In this example, each coupler may consume an average power of ˜100 mW. The overall power consumed by the coupler also depends on the power consumed by the sensors attached to the coupler.

The AC current that flows along the cable generates varying electric fields around the cable. The coupler harvests its power from the varying magnetic fields using a magnetic core that surrounds the fiber cable. The core is wound with metal turns, such as copper, that behaves like a secondary winding of a transformer. The fiber optic metal shield acts like a single turn primary winding. In FIG. 24, the reflected coupler load to the primary windings r1, r2, etc., represents the power consumed by the couplers. The obtained voltage is then dependent on the current that flows along the cable, and the equivalent impedance seen by the power source.

To minimize electromagnetic pollution, the frequency of the current source may be slowly swapped, e.g., between 400 Hz and 600 Hz. The power feeding may be used to synchronize the operation of the couplers. The main system control may transmit power at a first electrical power frequency that may prompt the couplers to enter a normal working state. Changing the electrical power frequency to a different frequency may prompt the couplers to enter a calibration state.

The system main control unit may modulate the electric power signal used for power feeding the couplers, in order to communicate with the couplers. Several types of modulation may be used, such as analog modulation, e.g. amplitude modulation, frequency modulation, or it may make use of digital modulation techniques such as ASK or FSK or any other suitable modulation. Since the power signal frequency pushed by the main system control is low, e.g. less than 10 kHz, the information rate that may be sent from the main system control to the deployed couplers is of low bit rate nature, mainly used for control and synchronization.

### Operational Mode Using Discrete Reflections

In some alternative embodiments, a third option for the system's configuration is provided (i.e., on top of the aforementioned transmission and reflection modes). In such embodiments, rather than having one optical path between the transmitter and the receiver (transmission mode) or numerous paths (backscatter/reflection mode), the link comprises a discrete number of pre-designed reflection points. These reflection points can be implemented in the link using Fiber Bragg Gratings (FBG). As an example, consider a system with a total length of 50 km and an FBG every 5 km. The reflection coefficient of each FBG can be designed to compensate for the round-trip loss in the fiber. Namely, the reflection coefficient of the FBG is designed to be Rₙ=Rₙ₋₁e^{2αΔL}/(1−Rₙ₋₁), where α is the attenuation coefficient of the fiber and ΔL is the distance between FBGs. The first reflection coefficient, R₁, is chosen to be sufficiently small in order to reduce the effect of multiple scattering. For example, R₁ can be chosen to be ˜0.5%. Even at this low value the FBG's reflection is orders of magnitude stronger than the Rayleigh backscatter level in the reflection mode. The signal induced by a coupler positioned between two consecutive reflectors is obtained by finding the phase difference between their reflections.

When a short pulse is transmitted into a fiber with N FBGs, the back-reflected light is a comb of N pulses. in the above described reflection mode, the pulse repetition rate is limited due to the round-trip time in the fiber to fₘₐₓ=c/(2L), where c is the speed of light in the fiber and L is the fiber length. In the proposed mode, the pulses are transmitted at significantly higher rates. The rates are designed such that the pulse combs which return after each transmitted pulse do not overlap. It is convenient to present all the relevant times in the technique as multiples of the pulse duration, τₚ. The reflection from a single point reflector generates a peak in the detected signal. The shape of the peak is similar to the transmitted pulse and its duration 1·τₚ. The time between two consecutive reflections from the discrete reflectors is represented by [symbol] τₚ where [symbol] is integer (τₚ, which can be tuned to fit an integer number of times within a time duration between two consecutive reflections). Denoting the time between two consecutive interrogations (pulse repetition time) as N, and the number of reflectors in the fiber as Mτₚ, the time slots where back-reflections occur in a scan period are (given normalized to τₚ): Pₙ=mod(n [symbol] ,M) {n=1, 2, 3 . . . , N}. The criterion for avoiding overlap between reflections from the discrete reflectors is that all the elements in the sequence Pₙ be different from one another, namely: Pₙ≠P_{q} ∀ n≠q {n,q=1,2,3 . . . N}. The minimum scan period which satisfies this criterion for a given number of reflectors, distance between them, and pulse duration, can be found with a computer program (see below). Using a code, it is possible to find parameters for fast interrogation of links with discrete reflectors. Some examples are given in Table 3:

TABLE 3

| Fiber | Number of | Distance between | Pulse | |
|---|---|---|---|---|
| length | discrete | discrete | duration | Scan rate |
| [km] | reflectors | reflectors [km] | [μs] | (PRF)[kHz] |
| 50 | 10 | 5 | 0.5 | 181 |
| 50 | 10 | 5 | 1 | 90 |
| 100 | 20 | 5 | 0.5 | 95 |
| 100 | 20 | 5 | 1 | 47 |
| 56 | 14 | 4 | 0.2 | 294 |
| 56 | 14 | 4 | 0.4 | 147 |
| 56 | 14 | 4 | 0.8 | 73.5 |

It can be seen that the scan rates are significantly higher than the regular round trip limit and that there is a trade-off between pulse duration and scan rate. By reducing the pulse duration, it is possible to achieve higher scan rates. A short software code may be applied to find the minimum scan period which satisfies the no-overlap criterion for a given number of reflectors, distance between them, and pulse duration.

Although the embodiments described herein mainly address sensor networks, the methods and systems described herein can also be used in other applications, such as in low-rate optical communication systems. Several non-limiting examples are agricultural control systems that control agricultural devices such as sprinklers and measure the resulting humidity, and communication systems for use in underground mines (in which wireless communication is often not feasible). Yet another example implementation is peripheral defense for ships, in which an optical cable with sensors and coupling devices are installed underwater around the submerged part of a ship.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1-17. (canceled)

18. An apparatus, comprising:
an acoustic transducer, which is coupled to an optical cable and is configured to modulate a mechanical strain applied to the optical cable with an acoustic signal, so as to modulate an optical signal traversing the optical cable with data; and
a mechanical element, which is configured to apply to the optical cable a returning force that opposes the mechanical strain applied by the acoustic transducer.

19. The apparatus according to claim 18, wherein the mechanical element is configured to apply pre-tension to the optical cable by pre-distorting a shape of the optical cable.

20. The apparatus according to claim 18, wherein the mechanical element comprises a spring.

21. The apparatus according to claim 18, wherein the mechanical element comprises a second acoustic transducer.

22. The apparatus according to claim 18, and comprising a flextural element, which is coupled between the acoustic transducer and the optical cable and is configured to amplify a force of the acoustic transducer.

23. The apparatus according to claim 18, wherein the acoustic transducer and the mechanical element comprise respective first and second flextural elements operating in anti-phase relative to one another.

24. The apparatus according to claim 18, wherein the acoustic transducer has a radius that varies as a function of the acoustic signal, so as to modulate the mechanical strain applied to the optical cable.

25. The apparatus according to claim 18, and comprising a proximity sensor configured to sense a vibration of the optical cable in response to the mechanical strain applied by the acoustic transducer.

26. The apparatus according to claim 25, and comprising a microcontroller, configured to adapt an amplitude of the acoustic signal provided to the acoustic transducer responsively to the vibration sensed by the proximity sensor.

27. A method, comprising:
using an acoustic transducer, which is coupled to an optical cable, modulating a mechanical strain applied to the optical cable with an acoustic signal, so as to modulate an optical signal traversing the optical cable with data; and
using a mechanical element, applying to the optical cable a returning force that opposes the mechanical strain applied by the acoustic transducer.

28-31. (canceled)

32. A system, comprising:
an optical source, configured to transmit optical signals having a same optical carrier frequency into different fibers of an optical cable, wherein optical signals propagating in different fibers are interlaced in time;
multiple coupler units, which are coupled to the optical cable and are each configured to (i) accept one or more configuration parameters, (ii) receive data from one or more sensors, (iii) modulate the data onto an acoustical signal in accordance with the configuration parameters, and (iv) modulate a mechanical strain applied to the optical cable with the acoustic signal, so as to modulate the optical signal with the data; and
a detector, configured to receive the interlaced optical signals from the optical cable, and to demodulate the data that was modulated onto the optical signal by the multiple coupler units.

33. The system according to claim 32, and comprising a controller, which is configured to coordinate and send the configuration parameters to the multiple coupler units.

34. The system according to claim 33, wherein the controller and a given coupler unit are configured to perform a closed-loop equalization process that equalizes a phase change across a bandwidth of the acoustic signal of the given coupler unit.

35. The system according to claim 32, wherein the coupler units are configured to harvest electrical power by induction from an electrical conductor that runs along the optical cable.
